(19) United States
(12) Patent Application Publication
(10) Pub. No.: US 2012/0236604 A1
(43) Pub. Date: Sep. 20, 2012

(54) FLYBACK CONVERTER WITH LEADING EDGE BLANKING MECHANISM

(75) Inventors: CHIH-CHAN GER, Jhongli City (TW); TSUNG-LIANG HUNG, Jhongli City (TW); YUN-BING WANG, Jhongli City (TW)

(73) Assignee: AMPOWER TECHNOLOGY CO., LTD., Jhongli City (TW)

(21) Appl. No.: 13/152,292

(22) Filed: Jun. 3, 2011

(30) Foreign Application Priority Data
Mar. 17, 2011 (CN) 201110064008.0

(51) Int. Cl. H02M 3/335

(52) U.S. Cl. 363/21.13

(57) ABSTRACT

A flyback converter having a leading edge blanking (LEB) element keeps detecting whether or not primary-side current of the flyback converter reaches a predetermined threshold, beyond which the flyback converter could be damaged, in a predetermined LEB time corresponding to a leading edge of primary-side current. The flyback converter is turned off when the primary-side current exceeds the predetermined threshold.

### BACKGROUND

1. Technical Field

The present disclosure relates to flyback converters, and particularly, to a flyback converter having a leading edge blanking (LEB) mechanism.

2. Description of Related Art

Flyback converters typically include a transformer, a switch, and a pulse width modulator (PWM) controller. The transformer includes a primary winding, which is electrically connected to an external power source through the switch when the switch is turned on. The PWM controller is connected to the switch and configured for generating a PWM signal which is used to control the switch on and off.

When the switch is turned on as being triggered by a leading edge, e.g., a rising edge, of the PWM signal, primary-side current, that is, current flowing through the primary winding, rises and electric energy of the external power source is transferred from the primary winding to the secondary winding.

To avoid the primary-side current from rising too high, which would damage the flyback converter, the PWM controller further measures the primary-side current, and the PWM signal is cut off when the primary-side current reaches a predetermined threshold for an over-current protection mechanism of the PWM controller. Accordingly, the switch is turned off as triggered by a trailing edge, e.g., a falling edge, of the PWM signal, and the primary-side current is cut off to protect the flyback converter.

However, a current spike is often generated in the primary-side current when the switch is turned on, that is, the spike often happens in the leading edge of the primary-side current. The spike is typically higher than the predetermined threshold but still falls within a safe range in which the flyback converter is safe. However, the switch is wrongly turned off as being triggered by the spike.

Therefore, an LEB mechanism is typically added to the PWM controller. The LEB mechanism disables the over-current protection mechanism in an LEB time corresponding to the leading edge of the primary-side current. That is, in the LEB time, the primary-side current is ignored by the over-current protection mechanism.

However, in some situations, for example, when the external power source is turned on, a great current spike exceeding the safe range may happen in the LEB time and is undesirably ignored, exposing the flyback converter to the risk of damage.

Therefore, it is desirable to provide a flyback converter, which can overcome the limitations described.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a circuit diagram of a flyback converter, according to an embodiment.

FIG. 2 is a timing chart of the flyback converter of FIG. 1, according to one embodiment.

### DETAILED DESCRIPTION

Embodiments of the present disclosure will now be described in detail with reference to the drawings.

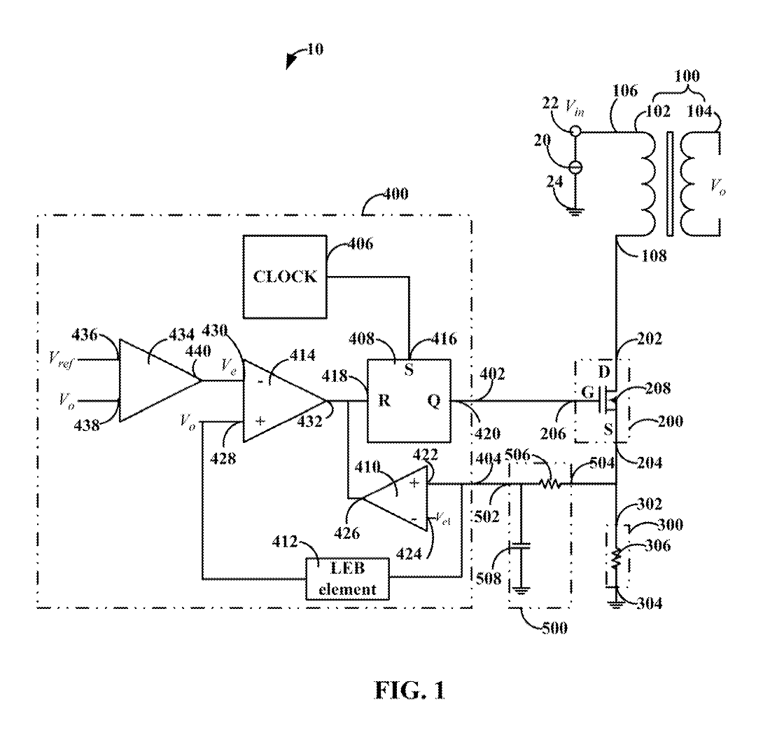

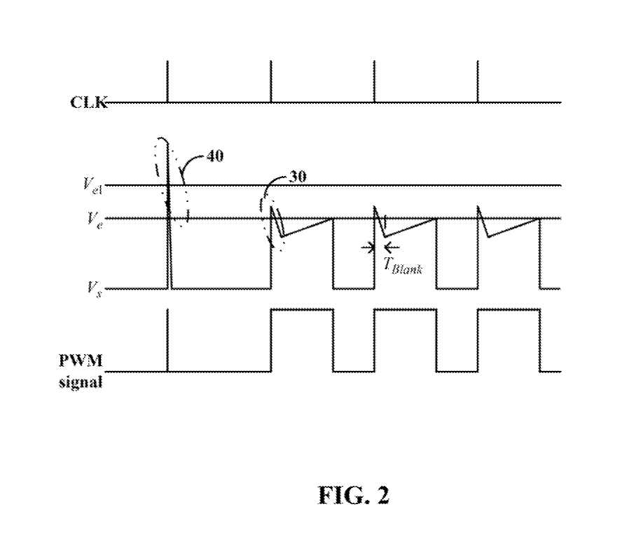

Referring FIGS. 1 and 2, a flyback converter 10, according to an embodiment, includes a transformer 100, a switch 200, a sampler 300, and a PWM controller 400. The transformer 100 includes a primary winding 102.

The primary winding 102 is electrically connected to an external power source 20 through the switch 200 and the sampler 300 when the switch 200 is turned on. The sampler 300 is configured for sampling current flowing through the primary winding 102, i.e., primary-side current, and generating a sample signal corresponding to the current. The PWM controller 400 is connected to the switch 200 and configured for generating a PWM signal configured to turn on the switch 200. The PWM controller 400 is configured for detecting whether or not the sample signal reaches a first predetermined threshold in a predetermined LEB time T_{Blank} and turning off the switch 200 when the sample signal reaches the first predetermined threshold. The PWM controller 400 is further configured for detecting whether or not the sample signal reaches a second predetermined threshold after the predetermined LEB time T_{Blank} and turning off the switch 200 when the sample signal reaches the second predetermined threshold.

The external power source 20 includes a positive electrode 22, e.g., a positive voltage electrode, and a negative electrode 24, e.g., ground. The external power source 20 is configured for providing an input voltage Vᵢₙ between the positive electrode 22 and the negative electrode 24. In addition to the primary winding 102, the transformer 100 also includes a secondary winding 104. The primary winding 102 includes two winding ends 106, 108. The switch 200 includes two switch terminals 202, 204 and a control terminal 206. The switch 200 is configured for connecting or disconnecting the switch terminals 202, 204 based upon the PWM signal received from the control terminal 206. The sampler 300 includes two sample ends 302, 304.

The winding end 106 is connected to the positive electrode 22 and the winding end 108 is connected to the switch terminal 202. The sample end 302 is connected to the switch terminal 204 and the sample end 304 is connected to the negative electrode 24, that is, the sample end 304 is grounded.

Thus, when the switch 200 is turned on, that is, when the switch terminals 202, 204 are connected, the primary winding 102 is connected to the external power source 20 and receives the input voltage Vᵢₙ. As a result, the current rises and electric energy of the external power source 20 is transferred from the primary winding 102 to the secondary winding 104. The secondary winding 104 outputs an output voltage Vₒ.

The switch 200 includes a field effect transistor (FET) 208 in this embodiment. The source S of the FET 208 is connected to the switch terminal 202, the drain D of the FET 208 is connected to the switch terminal 204, and the gate G is connected to the controller terminal 206. As such, the switch terminals 202, 204 are connected as being triggered by a rising edge, e.g., a leading edge, of the PWM signal and are disconnected as being triggered by a falling edge, e.g., a trailing edge. It should be noted that, in other embodiment, the switch 200 can take other forms, and the switch terminals 202 204 can be connected as being triggered by a falling edge of the PWM signal.

The sampler 300 includes a sampling resistor 306 connected between the sample ends 302, 304. The sample signal is a sample voltage Vₛ across the sampling resistor 306. Accordingly, the first predetermined threshold is a first threshold voltage Vₑ₁ beyond which the flyback converter 10 could be damaged, and the second predetermined threshold is a second threshold voltage Vₑ, which is less than Vₑ₁, which is set lower than the first threshold voltage Vₑ₁ to protect the flyback converter in a greater degree. In practice, the first predetermined threshold, e.g., the first threshold voltage Vₑ₁, can be measured or determined by, for example, experiments and/or experiences.

The PWM controller 400 includes a PWM output 402, a sample terminal 404, a clock 406, a set-reset flip-flop 408, a first comparator 410, an LEB element 412, and a second comparator 414.

The clock 406 is configured for generating a clock signal CLK that includes a set signal of the set-reset flip-flop 408.

The set-reset flip-flop 408 includes a set terminal 416, a reset terminal 418, and a latch output 420. The set-reset flip-flop 408 is configured to generate and send the rising edge of the PWM signal via the latch output 420 as being triggered by the set signal sending to the set terminal 416 and configured to generate and send the failing edge of the PWM signal via the latch output 420 as being triggered by a reset signal sending to the reset terminal 418.

The first comparator 410 includes a first positive input 422, a first negative input 424, and a first comparator output 426. The first comparator 412 is configured to generate and send the reset signal via the first comparator output 426 when the sample voltage Vₛ sending to the first positive input 422 reaches the first threshold voltage Vₑ₁ sending to the first negative input 424.

The LEB element 412 is configured for blanking a leading edge of the sample signal in the predetermined LEB time T_{Blank}. The predetermined LEB time T_{Blank} corresponds to the leading edge of the sample signal and can be determined by, for example, experiments and/or experiences.

The second comparator 414 includes a second positive input 428, a second negative input 430, and a second comparator output 432. The second comparator 414 is configured to generate and send the reset signal via the second comparator output 438 when the sample voltage Vₛ sending to the second positive input 428 reaches the second threshold voltage Vₑ sending to the second negative input 430.

The PWM output 402 is connected to the control terminal 206. The sample terminal 404 is connected to the sample end 302. The set terminal 416 is connected to the clock 406 to receive the clock signal CLK. The first positive input 422 is connected to the sample terminal 404 to receive the sample voltage Vₛ. The first negative input 424 is connected to a voltage source (not labeled) to receive the first threshold voltage Vₑ₁. The second positive input 428 is connected to the sample terminal 404 through the LEB element 412 to receive the sample voltage Vₛ after the predetermined LEB time T_{Blank}. The second negative input 430 is connected to a voltage source (see below) to receive the second threshold voltage Vₑ. The first comparator output 426 and the second comparator output 432 are connected to the reset terminal 418 to send the reset signal. The latch output 420 is connected to the PWM output 402.

Any part of the clock signal CLK, such as a rising edge or a falling edge, can act as the set signal depending on the characteristics of the set-reset flip-flop 408. Accordingly, the reset signal can be a rising edge or a falling edge sent from the first comparator 410 or the second comparator 412. In this embodiment, the rising edge, e.g., a leading edge, of the clock signal, acts as the set signal. Accordingly, the reset signal is the rising edge from the first comparator 410 or the second comparator 414. Thus, the set-reset flip-flop 408 generates and sends the rising edge of the PWM signal to the PWM output 402 via the latch output 420 when the set terminal 416 receives the rising edge of the clock signal CLK, and generate the falling edge of the PWM signal when the reset terminal 418 receives the rising edge form the first comparator 410 or the second comparator 414.

When the control terminal 206 receives the rising edge of the PWM signal via the PWM output 402, the switch 200 is turned on. At this moment, a voltage spike 30, which is typically lower than the first threshold voltage Vₑ₁ but is higher than the second threshold voltage Vₑ, often occur to the sample voltage Vₛ. This spike 30 is caused by the turn-on of the switch 200 and would not threaten the safe of the flyback converter 10. However, the spike 30 would cause the second comparator 414 output the reset signal since the spike 30 is higher than the second threshold voltage Vₑ. However, in this embodiment, the spike 30 is blanked by the LEB element 412 and thus is ignored by the second comparator 414 in the predetermined LEB time T_{Blank}. That is, in the predetermined LEB time T_{Blank}, the second comparator 414 is disabled.

However, in the predetermined LEB time T_{Blank}, the first comparator 410 keeps detecting whether or not the sample signal reaches the first predetermined threshold. That is, the first comparator 410 compares the sample voltage Vₛ with the first threshold voltage Vₑ₁ in the predetermined LEB time T_{Blank} and determines that the sample signal reaches the first predetermined threshold when the sample voltage Vₛ increases to the first threshold voltage Vₑ₁.

Actually, if a large voltage spike 40, which is caused by, for example, the turn-on of the external source 20, occurs, the sample voltage Vₛ may suddenly increase over the first threshold voltage Vₑ₁ and the flyback converter 10 is at the risk of damage. The large voltage spike 40 happening in the predetermined time T_{Blank} would be ignored by a conventional flyback converter and causes damage. However, the large voltage spike 40 will be recognized by the second comparator 414 and the reset signal is corresponding generated and sent to the reset terminal 418. Thus, the falling edge of the PWM signal is generated and sent to turn off the switch 200, and thus the current is cut off to protect the flyback converter 10 from being damaged.

If the large spike 40 does not happen in the predetermined LEB time T_{Blank}, the switch 200 keeps on, and the current keeps increasing. Meanwhile, the second comparator 414 starts detecting whether or not the sample signal reaches the second predetermined threshold after the predetermined LEB time T_{Blank}. That is, the second comparator 414 compares the sample voltage Vₛ with the second threshold voltage Vₑ and determines that the sample signal reaches the second predetermined threshold when the sample voltage Vₛ increases to the first threshold voltage Vₑ.

The reset signal is generated by the second comparator 414 and sent to reset terminal 428 via the second comparator output 432 when the sample voltage Vₛ increases to the first threshold voltage Vₑ after the predetermined LEB time T_{Blank}. The falling edge of the PWM signal is generated by the set-reset flip-flop 408 as being triggered by the reset signal sending to the reset terminal 418 via the second comparator output 432. Thus, the switch 200 is turned off as being triggered by the falling edge of the PWM signal and the current is cut off until another set signal, i.e., anther rising edge of the clock signal CLK, is sent to the set terminal 416.

In this embodiment, the PWM controller 400 further includes an error amplifier 434 and the first threshold voltage Vₑ is determined by the error amplifier 434. The error amplifier 434 includes two amplifier inputs 436, 438, and an amplifier output 440. The amplifier input 436 is connected to a voltage source (not labeled) providing a reference voltage V_{ref}. The amplifier input 438 is connected to the secondary winding to receive the output voltage Vₒ. The amplifier output 440 is connected to the second negative input 430. The error amplifier 434 is configured to amplify difference between the reference voltage V_{ref} and the output voltage Vₒ (i.e., the error) and configured to output the amplified difference as the first threshold voltage Vₑ to the second negative input 430 via the amplifier output 440.

The flyback converter 10 also includes a low-pass filter 500. The sample terminal 404 is connected to the sample end 302 through the low-pass filter 500. The low-pass filter 500 includes two filter ends 502, 504, a resistor 506 and a capacitor 508. The filter end 502 is connected to the sample terminal 404 and is grounded through the capacitor 508. The resistor 506 is connected between the filter ends 502, 504. The filter end 504 is connected to the sample end 302.

It will be understood that the above particular embodiments are shown and described by way of illustration only. The principles and the features of the present disclosure may be employed in various and numerous embodiment thereof without departing from the scope of the disclosure as claimed. The above-described embodiments illustrate the scope of the disclosure but do not restrict the scope of the disclosure.

What is claimed is:

1. A flyback converter, comprising:
a transformer comprising a primary winding;
a switch;
a sampler, wherein the primary winding is electrically connected to an external power source through the switch and the sampler when the switch is turned on, the sampler configured for sampling current flowing through the primary winding and generating a sample signal corresponding to the current; and
a pulse width modulation (PWM) controller connected to the switch and configured for generating a PWM signal configured to turn the switch on and off, the PWM controller being configured for detecting whether or not the sample signal reaches a first predetermined threshold in a predetermined leading edge blanking (LEB) time corresponding to a leading edge of the sample signal and turning off the switch if the sample signal reaches the first predetermined threshold, the PWM controller being further configured for detecting whether or not the sample signal reaches a second predetermined threshold after the predetermined LEB time and turning off the switch if the sample signal reaches the second predetermined threshold.

2. The flyback converter of claim 1, wherein the switch comprises two switch terminals and a control terminal, one of the switch terminals is connected to the primary windings and the other switch terminal is connected to the sampler, the control terminal is connected to the PWM controller, and the switch is configured for connecting or disconnecting the switch terminals based upon the PWM signal sending to the control terminal.

3. The flyback converter of claim 2, wherein the switch comprises a field effect transistor which comprises a source, a drain, and a gate, the source is connected to one of the switch terminals and the drain is connected to the other switch terminal, the gate is connected to the control terminal, and the switch terminals are connected when the control terminal receives a rising edge of the PWM signal and are disconnected when the control terminal receives a falling edge of the PWM signal.

4. The flyback converter of claim 1, wherein the sampler comprises two sample ends, one of the sample end is connected to the switch and the other sample end is connected to the power source, the sampler further comprises a sampling resistor connected between the sample ends, and the sample signal is a sample voltage across the sampling resistor.

5. The flyback converter of claim 4, wherein the first predetermined threshold is a first threshold voltage, beyond which the flyback converter could be damaged.

6. The flyback converter of claim 5, wherein the second predetermined threshold is a second threshold voltage which is set lower than the first threshold voltage.

7. The flyback converter of claim 1, wherein the PWM controller comprises a clock configured to generate a clock signal comprising a set signal.

8. The flyback converter of claim 7, wherein the PWM controller comprises a PWM output and a set-reset flip-flop, the PWM output is connected to the switch for outputting the PWM signal, the set-reset flip-flop comprises a set terminal, a reset terminal, and a latch output, the set terminal is connected to the clock to receive the clock signal, the latch output is connected to the PWM output, and the set-reset flip-flop is configured to generate and send a first edge for turning on the switch to the PWM output via the latch output as being triggered by the set signal sending to the set terminal and configured to generate a second edge for turning off the switch to the PWM output via the latch output as being triggered by a reset signal sending to the reset terminal.

9. The flyback converter of claim 8, wherein the PWM controller comprises a sample terminal and a first comparator, the sample terminal is connected to the sampler to receive the sample signal, the first comparator comprises a first negative input, a first positive input, a first comparator output, the first positive input is connected to the sample terminal to receive the sample signal, the first negative terminal is configured to receive the first predetermined threshold, and the first comparator output is connected to the reset terminal, the first comparator is configured to generate and send the reset signal to the reset terminal via the first comparator output when the sample signal increases to the first predetermined threshold in the predetermined LEB time.

10. The flyback converter of claim 8, wherein the PWM controller comprises a sample terminal and a second comparator, the sample terminal is connected to the sampler to receive the sample signal, the second comparator comprises a second positive input, a second negative input, and a second comparator output, the second positive input is connected to the sample terminal to receive the sample signal, the second negative input is configured to receive the second predetermined threshold, the second comparator output is connected to the reset terminal, and the second comparator is configured to generate and send the reset signal to the reset terminal via the second comparator output when the sample signal increases to the second predetermined threshold after the predetermined LEB time.

11. The flyback converter of claim 10, wherein the PWM controller comprises an LEB element, the second positive input is connected to the sample terminal via the LEB element, and the LEB element is configured for blanking the sample signal in the predetermine LEB time.

12. The flyback converter of claim 10, wherein the transformer further comprises a secondary winding, electric energy of the external power source is transferred from the primary winding to the secondary winding after the switch is turned on, the secondary winding outputs an output voltage, the PWM controller further comprises an error amplifier, the error amplifier comprises two amplifier input and an amplifier output, one of the amplifier input is connected to the secondary winding to receive the output voltage and the other is configured to receive a reference voltage, the amplifier output is connected to the second negative input, the amplifier is configured to amplify the difference between the reference voltage and the output voltage and configured to output the amplified differences as the first predetermined threshold to the second negative input via the amplifier output.
